(19) United States
(12) Patent Application Publication
(10) Pub. No.: US 2006/0038040 A1
(43) Pub. Date: Feb. 23, 2006

(54) Hose-end sprayer improvements

(76) Inventors: Richard W. Faupel, Sebring, FL (US); Wayne C. Faupel, Bedford, PA (US)

Correspondence Address: Ian K. Samways;Reed Smith LLP, P.O. Box 488, Pittsburgh, PA, 15230-0488, US

(21) Appl. No.: 11/206,242

(22) Filed: Aug. 16, 2005

Related U.S. Application Data
(60) Provisional application No. 60/602,148, filed on Aug. 16, 2004.

(51) Int. Cl. B05B 7/04

(52) U.S. Cl. 239/398

(57) ABSTRACT

Methods and arrangements for directing an incoming flow of concentrated product, as it is introduced into the flow-by stream of carrier fluid (e.g., water), in such a manner as to much more favorably disperse the concentrated chemical product throughout virtually the entire cross-section of carrier fluid. Hence, there are presently contemplated some structural features for directing the flow of the concentrated product into the carrier stream flow-by in a way to result in dispersal throughout essentially the entire cross section of the flow-by.

This application claims priority under 35 U.S.C. 119(e) from U.S. Provisional Patent Application Ser. No. 60/602,148, filed on Aug. 16, 2004.

### FIELD OF THE INVENTION

The present invention generally relates to hose-end sprayers and, in particular, to arrangements associated therewith for facilitating the mixture of substances.

### BACKGROUND OF THE INVENTION

Hose-end aspirating sprayers, as presently known, are generally configured to deliver a diluted mixture (comprising, e.g., a carrier stream such as water and another substance or product) onto a surface or area to be treated. Such sprayers are commonly used to apply chemical products to lawns and/or gardens.

Generally, two main types of aspirating hose-end sprayer devices are known. A first main type is the “venturi” style, using a classical venturi flow arrangement to facilitate aspiration. A second main type is the “flow-by” style, using a high velocity stream of water (from a hose) to impinge on a surface and flow by an aspirating orifice (itself in fluid communication with, e.g., a concentrated product to be delivered).

Of these two types of hose-end aspirating sprayers, the flow-by sprayer is most commonly used for ready-to-dispense (i.e., off of the store shelf) applications. The simple design of the device renders it less expensive to manufacture, thereby lending itself to disposable applications.

However, unlike the venturi style aspirating sprayer, the flow-by sprayer generally presents difficulties in creating a desirably homogeneous mixture of the carrier stream (e.g., water) and the product aspirated from the container. Particularly, flow-by sprayers tend to promote the concentration of the diluted mixture towards the core of the resultant spray pattern, rather than ensuring that the aspirated substance is distributed more evenly throughout the spray pattern. Most end users are not aware of this functional disadvantage, mostly because the phenomenon is not readily visible. (Typically, dilution rates for the associated chemistries are very high, to promote some efficiency in the dispensing process.) In sum, the disproportionate allocation of diluted product to a limited region of the resultant spray pattern is highly undesirable and usually results in a very uneven application of diluted chemical product on the surface to be treated.

Generally, several U.S. Patents discuss spraying arrangements which present stark design and performance disadvantages in comparison with embodiments of the present invention. Such patents include: U.S. Pat. No. 6,749,133 (Ketcham, et al.); U.S. Pat. No. 6,578,776 (Shanklin, et al.); U.S. Pat. No. 6,378,785 (Dodd); U.S. Pat. No. 5,383,603 (Englhard, et al.); U.S. Pat. No. 5,372,310 (Ketcham); U.S. Pat. No. 5,213,265 (Englhard, et al.); U.S. Pat. No. 5,100,059 (Englhard, et al.); U.S. Pat. No. 5,039,016 (Gunzel, Jr., et al.); U.S. Pat. No. 4,527,740 (Gunzel, Jr., et al.); U.S. Pat. No. 4,475,689 (Hauger, et al.); U.S. Pat. No. 4,369,921 (Beiswenger, et al.); U.S. Pat. No. 4,349,157 (Beiswenger, et al.); U.S. Pat. No. 3,180,580 (Schedel); U.S. Pat. No. 2,719,704 (Anderson, et al.).

Generally, conventional flow-by arrangements are not known to provide any feature that causes aspirated product to spread and mix in a homogeneous fashion. On the other hand, in connection with a venturi spray arrangement, Dodd (U.S. Pat. No. 6,378,785) appears to disclose a roughened deflector surface to facilitate a spray pattern. However, this feature does not appear to significantly promote homogenous mixing.

In view of the foregoing, a need has been recognized in connection with improving upon the shortcomings and disadvantages presented by conventional arrangements.

### SUMMARY OF THE INVENTION

There are broadly contemplated, in accordance with at least one presently preferred embodiment of the present invention, methods and arrangements for directing an incoming flow of concentrated product, as it is introduced into the flow-by stream of carrier fluid (e.g., water), in such a manner as to much more favorably disperse the concentrated chemical product throughout virtually the entire cross-section of carrier fluid passing the aspiration orifice. As such, it is recognized that this cannot be accomplished in a direct, “linear” manner, as excess flow-by fluid “overlap” is normally required to seal off the atmosphere outside the container (and thus ensure that all the lower-than-atmospheric pressure produced works solely upon the contents of the container). Hence, there are presently contemplated herein some structural features for directing the flow of the concentrated product into the carrier stream flow-by in a way to result in dispersal throughout essentially the entire cross section of the flow-by.

In addition, there is broadly contemplated herein the inclusion of additional subtle surface features, within the aforementioned structural features, for directing the flow of the concentrated product into the carrier stream, to help further break up and disperse the product and thereby further enhance the mixing. Additionally, surface texture and/or surface features may be provided on the sprayer surface downstream from the structural features directing the product flow into the carrier stream to improve the final mixed-product consistency. Even tailoring the length of the surface after the aspiration orifice may aid in further promoting the homogeneity of the resultant spray pattern.

Generally, there is broadly contemplated in accordance with at least one presently preferred embodiment of the present invention a hose-end sprayer arrangement comprising: a carrier stream conduit for directing a carrier stream; an inlet for accepting another substance to be mixed into the carrier stream; and at least one surface alteration configured for promoting homogenous mixing of the carrier stream and accepted substance.

### BRIEF DESCRIPTION OF THE DRAWINGS

The present invention and its presently preferred embodiments will be better understood by way of reference to the detailed disclosure herebelow and to the accompanying drawings, wherein:

FIG. 1 is a perspective view of a hose-end connection;

FIG. 2 is a perspective cut-away view of the hose-end connection of FIG. 1;

FIG. 3 is a plan view of a slide portion of a conventional flow-by hose-end connection;

FIG. 4 is a plan view of a slide portion of a flow-by hose-end connection but showing groove-type features in accordance with an embodiment of the present invention;

FIG. 5 shows essentially the same arrangement as FIG. 4, but with additional features; and

FIG. 6 is a plan view of another embodiment of a slide portion of a flow-by hose-end connection.

### DESCRIPTION OF THE PREFERRED EMBODIMENTS

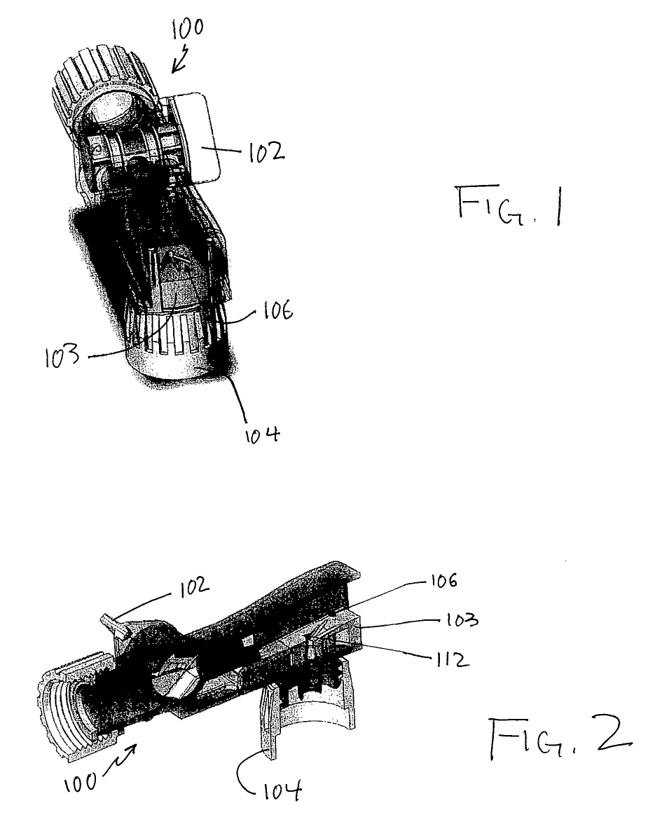

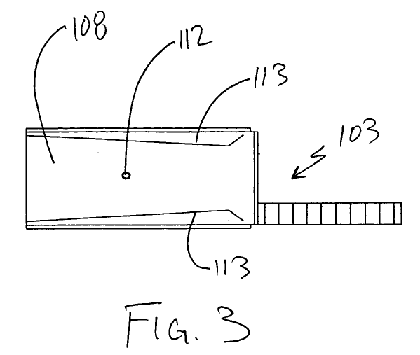

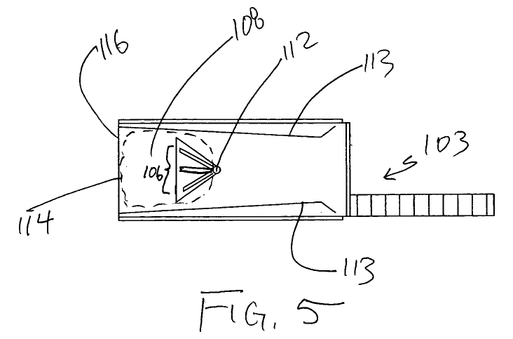

FIGS. 1 and 2 are perspective views of a hose-end connection 100 that could employ the features discussed heretofore. As shown, such a hose-end connection 100 may include a flow control arrangement (e.g. a rotating knob) 102 adapted to propagate a slide 103 (better appreciated in FIG. 4). As is well-known, slide 103 may be displaceable in a longitudinal direction such that an aspiration hole 112 thereof is selectively positioned above an inlet port in a connection 104 to a container containing product (e.g. a lawn treatment chemical product) for being mixed into a carrier stream (e.g. water). Also shown is aspirating surface 108, or a “floor” of slide 103, in which grooves 106 and hole 112 are disposed. It should be noted that the use of a slide as mentioned herein is but an optional feature of an environment in which the embodiments of the present invention may be employed.

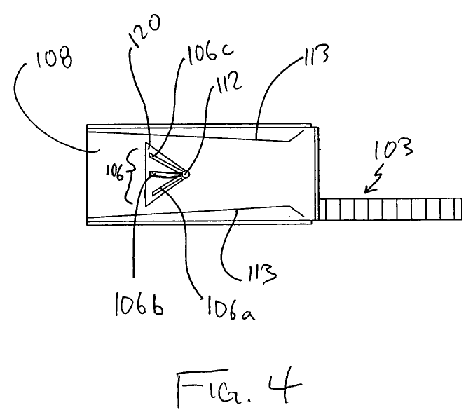

FIG. 3 is a plan view of a slide 103, where there is simply an orifice (aspiration hole) 112 through which product is aspirated and no other arrangement for ensuring a homogenous spray pattern. Also shown are walls (or side rails) 113 flanking aspirating surface 108.

FIG. 4 shows essentially the same slide as FIG. 3, but with the inclusion of groove-type features 106 in accordance with an embodiment of the present invention.

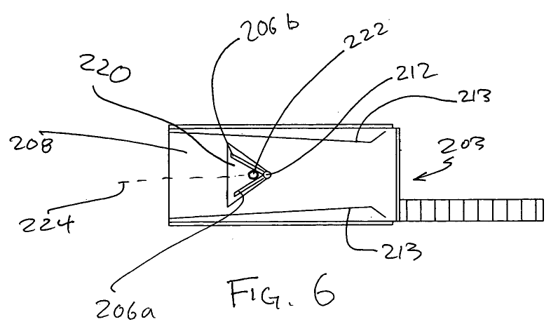

Here, there are three grooves 106a/b/c essentially extending from the aspiration hole 112 in the general forward direction of carrier stream flow. One groove (106b) is oriented essentially directly in parallel with the carrier stream flow while the other two grooves (106a, 106c) are oriented at a predetermined acute angle to either side of the central groove 106b. As shown, grooves 106a, 106c may preferably extend nearly all the way to walls 113. Optionally, a trough 120 may be provided similar to the trough 220 described herebelow with reference to FIG. 6, though it is not essential.

FIG. 5 shows essentially the same slide arrangement 103 as FIG. 4, but contemplates the addition of some additional surface features (in the general vicinity circumscribed by dotted line 114) for enhancing homogenous mixing even further (discussed in more detail below).

In one embodiment of the present invention the depth of each groove 106 a/b/c will taper to (essentially) zero with increasing distance from the aspiration hole 112 and in the direction of flow of the carrier stream, to essentially merge seamlessly with aspiration surface 108.

As to the types of surface features that may be provided at or within the grooves (FIG. 5), a wide variety of configurations are possible. For instance, a roughened surface may be provided inside individual grooves 106a/b/c or in the vicinity of the grooves 106. Alternatively or in addition, a roughened surface may be provided downstream (with respect to the carrier stream flow) of the grooves 106, i.e., just after the grooves 106 and before the fluid leaves the aspiration surface 108 into the air as a spray (e.g. at a lip portion 116 of slide 103).

In addition to or instead of surface roughening, there could be provided downstream of the grooves more discrete surface features or irregularities, such as small bumps or depressions (e.g., hemispherical bumps/depressions as may be found on a golf ball); this could easily compel fluid particles to bounce and deflect, and thus intermix with other adjacent particles. Other possibilities in such a location offering similar effect could include small ridges (e.g. elongated protrusions from the aspirating surface 108) or minor grooves (e.g. small grooves running perpendicularly with respect to carrier stream flow).

FIG. 6 illustrates, in plan view, a particularly preferred embodiment of a slide in accordance with the present invention. As shown, a slide 203 may have an aspiration hole 212 that feeds into an arrangement comprising grooves 206a/b and a trough 220. Particularly, a trough 220, as shown, may preferably be defined by sides that radiate from hole 212. The trough 220 may preferably have a varying depth that ranges from a maximum at hole 212 to a minimum away from hole 212. Grooves 206a/b, for their part, preferably also radiate from hole 212 each at an acute angle (with respect to an imaginary line 224 essentially bisecting the lie of grooves 206a/b) that is less than the angle defined by the walls of trough 220 (with respect to the same line 224). Preferably disposed between the grooves 206a/b, in the general vicinity of hole 212, is a dimple, or raised bump, 222. The dimple 222 preferably abuts directly onto both grooves 206a and 206b as shown. It has been found that an arrangement, having grooves with a dimple substantially as shown, performs exceptionally well at promoting a homogenous mix of product into a carrier stream. Side rails 213 may be included as with FIGS. 4 and 5 but are not essential. It should be understood that the embodiment of FIG. 6 may optionally include other features such as discussed heretofore, e.g., additional surface features as indicated at 114 in FIG. 5 and as discussed heretofore.

It has been found that arrangements such as those illustrated in FIGS. 1, 2, 4, 5 and 6 are particularly favorable in promoting a homogenous mixture of carrier stream and product. It should be understood, however, that a wide range of other configurations are possible within the available space inside the hose-end connection that still produce highly favorable results.

Regarding all embodiments contemplated and embraced herein, when considering the length of the lower surface in the hose and connection subsequent to the aspiration hole (i.e., with respect to the direction of flow of the carrier stream), it will be appreciated by those of ordinary skill in the art that this will have a tangible effect on the spray pattern. More particularly, tailoring that length will clearly have an effect on how long or deep the grooves would need to be in order to achieve reasonably homogenous intermixing of carrier stream and product; likewise, tailoring the length, depth, number, angular orientation and other physical aspects of the grooves will have an effect on how much length will be needed between the aspiration hole and the lip (or exit portion) of the surface where the carrier stream leaves as a spray. Other factors, of course, can be included in such reckoning such as possible surface roughening and indentations/bumps (whether in or near the grooves or downstream of the grooves); the presence and extent of features will thus also have an effect on the physical aspects of the grooves and/or a dimple, or on the length of aspiration surface (subsequent to the aspiration hole), that would be needed in order to promote suitably homogenous mixing of the carrier stream and product.

Experimentation was conducted on a nozzle employing inventive features consistent with those discussed heretofore (such as in the embodiment of FIG. 4), against conventional nozzles lacking such features.

Each nozzle was secured to a rotatable turntable and aligned with a slit. “Product” was provided in the form of colored dye. The water and “product” were then turned on, and these were collected in a container adjacent the slit. The sample was then weighed and the ratio of water to dye was then determined using color matching with known ratios within a sample test tube rack. The turntable was then turned one degree to the right and the sampling procedure was repeated. This procedure was followed throughout both the left and right quadrants of the main flow stream.

The first nozzle tested was a Green Garden Products “K-1” with inventive features (as in FIG. 4). It was found that with an “inventive” nozzle, the product flow was nearly uniform throughout the main body of the spray.

A second nozzle, bearing no difference from the first nozzle other than the use of a conventional “slide” (as in FIG. 3), showed wide variations in product flow per degree of arc.

A third nozzle, different from the second but still having a conventional configuration with aspirating features similar to FIG. 3, showed product flow varying by more than 2½ to 1 throughout the main portion of the spray. Of course, such poor product distribution is undesirable when trying to achieve uniform product coverage over a large area.

Finally, a fourth nozzle tested, different from the others while still having a conventional configuration with aspirating features similar to FIG. 3, demonstrated the worst uniformity of product distribution of the nozzles tested. Noticeable was an intense centerline spray with large gaps in flow between the larger flow streams.

The nozzles selected for testing were commonly used impact type hose end sprayers. It was clearly found that an aspiration arrangement as inventively contemplated herein can represent a breakthrough in providing uniformity in applications of hose-end products.

In brief recapitulation, there is broadly contemplated in accordance with at least one presently preferred embodiment of the present invention a hose-end sprayer arrangement which includes a carrier stream conduit and an inlet port for accepting another substance to be mixed into the carrier stream. Preferably provided is at least one surface alteration configured for promoting homogenous mixing of the carrier stream and accepted substance. The at least one surface alteration may be in the form of at least one groove oriented along an acute angle with respect to the direction of flow of the carrier stream.

In accordance with a preferred embodiment of the present invention, there may be a plurality of such grooves.

The aforementioned angle is preferably greater than zero. Preferably, there are two grooves which are oriented substantially symmetrically with respect to one another on opposite sides of an imaginary bisecting central line which runs parallel to a direction of flow of the carrier stream.

Preferably, there may be a dimple disposed between the two grooves. The dimple is preferably a single raised bump which abuts a portion of each of the two grooves.

The carrier stream conduit may include a trough, the trough including sides which radiate from the inlet and a floor having a depth which varies from a maximum depth at the inlet to a minimum depth away from the inlet, wherein at least one groove is recessed into the floor of the trough.

In one embodiment of the present invention, there may be three grooves, wherein one is oriented essentially in parallel with respect to the direction of flow of the carrier stream and the other two may each be oriented along a distinct, predetermined acute angle (greater than zero) with respect to the direction of flow of the carrier stream. The two grooves not oriented in parallel with respect to the “central groove” (i.e., that groove which is oriented essentially in parallel with respect to the direction of flow of the carrier stream) may be oriented essentially symmetrically with respect to one another on either side of the central groove. Those two grooves preferably extend nearly all the way to walls defining the carrier stream conduit.

The grooves may preferably be of a maximum depth immediately adjacent the inlet port (i.e., right where the inlet port enters the carrier stream conduit) and this depth may then preferably taper for each groove in a direction generally away from the inlet port (or aspiration hole) for the accepted substance, preferably to the point where the depth of each groove essentially tapers to zero and thus seamlessly merges with a major internal surface of the carrier stream conduit.

Surface perturbations may preferably be provided inside of or in the vicinity of the grooves (e.g., in space between adjacent grooves). Alternatively or in addition, such perturbations may be provided between the “end” of the grooves (as defined in the direction of flow of the carrier stream) and a lip portion of the carrier flow conduit (i.e., where the carrier flow stream would exit the conduit for being aspirated into the air). The surface perturbations can take any of a very wide variety of different forms, which may include (but are by no means limited to): general surface roughening; bumps; ridges; indentations; recesses; minor grooves (e.g., oriented in a perpendicular direction with respect to the direction of flow of the carrier stream).

Without further analysis, the foregoing will so fully reveal the gist of the present invention and its embodiments that others can, by applying current knowledge, readily adapt it for various applications without omitting features that, from the standpoint of prior art, fairly constitute characteristics of the generic or specific aspects of the present invention and its embodiments.

If not otherwise stated herein, it may be assumed that all components and/or processes described heretofore may, if appropriate, be considered to be interchangeable with similar components and/or processes disclosed elsewhere in the specification, unless an express indication is made to the contrary.

If not otherwise stated herein, any and all patents, patent publications, articles and other printed publications discussed or mentioned herein are hereby incorporated by reference as if set forth in their entirety herein.

It should be appreciated that the apparatus and method of the present invention may be configured and conducted as appropriate for any context at hand. The embodiments described above are to be considered in all respects only as illustrative and not restrictive. All changes which come within the meaning and range of equivalency of the claims are to be embraced within their scope.

What is claimed is:

1. A hose-end sprayer arrangement comprising:
a carrier stream conduit for directing a carrier stream;
an inlet for accepting another substance to be mixed into the carrier stream; and
at least one surface alteration configured for promoting homogenous mixing of the carrier stream and accepted substance.

2. The sprayer arrangement according to claim 1, wherein said at least one surface alteration comprises at least one groove oriented along an acute angle with respect to a direction of flow of the carrier stream.

3. The sprayer arrangement according to claim 2, wherein said at least one surface alteration comprises a plurality of grooves.

4. The sprayer arrangement according to claim 3, wherein the acute angle is greater than zero.

5. The sprayer arrangement according to claim 4, wherein said at lease one groove comprising two grooves, said two grooves being oriented substantially symmetrically with respect to one another on opposite sides of an imaginary bisecting central line which runs parallel to a direction of flow of the carrier stream.

6. The sprayer arrangement according to claim 3, wherein said at least one groove comprises two grooves radiating from said inlet and a dimple disposed between said two grooves.

7. The sprayer arrangement according to claim 6, wherein said dimple comprises a single raised bump which abuts a portion of each of said two grooves.

8. The sprayer arrangement according to claim 3, wherein:
said carrier stream conduit comprises a trough;
said trough comprising sides which radiate from said inlet and a floor having a depth which varies from a maximum depth at said inlet to a minimum depth away from said inlet;
said at least one groove being recessed into said floor of said trough.

9. The sprayer arrangement according to claim 3, wherein:
said plurality of grooves comprise three grooves;
a first one of said grooves being oriented essentially in parallel with respect to a direction of flow of the carrier stream; and
a second one and a third one of said grooves being oriented along a predetermined acute angle with respect to the direction of flow of the carrier stream.

10. The sprayer arrangement according to claim 3, wherein said at least one surface alteration comprises surface perturbations disposed inside each of said grooves.

11. The sprayer arrangement according to claim 3, wherein said at least one surface alteration comprises surface perturbations disposed between adjacent ones of said grooves.

12. The sprayer arrangement according to claim 3, wherein said at least one surface alteration comprises surface perturbations disposed in the vicinity of said grooves.

13. The sprayer arrangement according to claim 12, wherein:
said grooves comprise terminal portions, disposed away from said inlet, where said grooves terminate at a surface of said carrier stream conduit;
said carrier stream conduit comprises an exit portion at which a carrier stream exits said carrier stream conduit;
said surface perturbations are provided between said terminal portions of said grooves and said exit portion of said carrier stream conduit.

14. The sprayer arrangement according to claim 3, wherein said at least one surface alteration further comprises general surface roughening disposed on a surface of said carrier stream conduit.

15. The sprayer arrangement according to claim 3, wherein said at least one surface alteration further comprises depressions disposed in a surface of said carrier stream conduit.
